(19) United States
(12) Patent Application Publication
(10) Pub. No.: US 2006/0070928 A1
(43) Pub. Date: Apr. 6, 2006

(54) Method and apparatus for identifying and sorting objects

(76) Inventors: Odd Lovhaugen, Oslo (NO); Kari Anne Hestnes Bakke, Oslo (NO); Volker Rehrmann, Koblenz (DE)

Correspondence Address: Eric T. Jones;Reising, Ethington, Barnes,, Kisselle, Learman & McCulloch, PO Box 4390, Troy, MI, 48099-4390, US

(21) Appl. No.: 10/501,657

(22) PCT Filed: Jan. 15, 2003
(86) PCT No.: PCT/GB03/00141

§ 371 Date: Jan. 14, 2005

(30) Foreign Application Priority Data
Jan. 16, 2002 (GB) 0200922.3
May 10, 2002 (GB) 0210626.8

(51) Int. Cl. B07C 5/00

(52) U.S. Cl. 209/576; 209/577

(57) ABSTRACT

A system of identifying and/or sorting of matter including an advancing device (101) for advancing the matter, a radiation emitting device (107) serving to emit radiation which is varied by the advancing matter, a detecting arrangement (103) serving to detect the varied radiation, and an analysing arrangement (106) serving to analyse the varied radiation. A spectral analyser (104) serves to detect the varied radiation in a plurality of narrow wavelength bands in the visible spectrum in order to determine the colour and/or composition of the matter. The system may also include another spectral analyser (105) operable in the invisible wavelength spectrum to analyse radiation which has been varied by the matter and is in the invisible wavelength spectrum. The system may further include a colour camera (102) and an arrangement which applies camera image interpretation to radiation which has been varied by the matter. The analysing arrangement (106) controls the operation of air valves for compressed air nozzles (109) so as to eject wanted or unwanted matter from the advancing device (101).

This invention relates to automatic identifying and/or sorting of matter.

Waste cellusolic material includes white paper, coloured paper, cartons and corrugated cardboard. These may or may not be printed, for example CMYK or black-ink printed, such as for newsprint, illustrated magazines and books.

Today the sorting process is to a large degree carried out manually.

WO-A-01/57497 discloses a paper sorting system which sorts individual sheets of paper, in a high speed stream of waste paper, on the basis of colour of the paper, glossiness of the paper, and the presence of printed matter on the paper. The system comprises a light-emitting array which consists of a row of infrared LED's, a row of red LED's, a row of green LED's, and a row of blue LED's, which sequentially flash to emit light of differing wavelengths onto the stream of waste paper. The system also comprises a receiving array containing multiple lens and photo-diode pairs for receiving light reflected from the waste paper and a paper analysis system. The paper analysis system includes a colour determination component, a glossiness determination component, and a printed matter determination component. The colour determination component determines the colour of the paper based upon those output signals from the receiving array representative of the reflected light originally emitted by the red, green and blue LED's. The glossiness determination component employs those output signals from the receiving array representative of the reflected infrared originally emitted by the infrared LED's. The paper printed matter determination component determines the presence of printed matter on the paper to be sorted by measuring differences in colour intensity between adjacent target areas on an individual piece of waste paper.

According to a first aspect of the present invention, there is provided a method of sorting matter, including advancing the matter, and determining colour and/or composition of the advancing matter by irradiating the matter with radiation which is varied by the matter, and analysing the varied radiation in a plurality of narrow wavelength bands in the visible spectrum.

According to a second aspect of the present invention, there is provided apparatus for use in sorting matter, including an advancing device for advancing the matter, a radiation-emitting device serving to emit radiation which is varied by the advancing matter, a detecting arrangement serving to detect the varied radiation, and an analysing arrangement serving to analyse the varied radiation in a plurality of narrow wavelength bands in the visible spectrum in order to determine colour and/or composition of the matter.

The analysing of the varied radiation in a plurality of narrow wavelength bands in the visible spectrum makes it possible to determine accurately the colour and/or composition of matter in an automatic manner.

Preferably, the analysing of the varied radiation in the plurality of narrow wavelength bands in the visible spectrum may be used to identify whether or not the matter is CMYK-printed matter.

According to a third aspect of the present invention, there is provided a method of separating, from a mixture of objects, objects that exhibit a specific characteristic related to colour of the objects, which characteristic is not detectable by the naked eye or a colour camera, comprising advancing said mixture, determining, using radiation, whether a portion of said mixture exhibits said characteristic and separating from the mixture the objects exhibiting said characteristic as desired portions of the mixture.

According to a fourth aspect of the present invention, there is provided apparatus comprising a device for producing advancement of a mixture of objects, a determining arrangement which uses radiation to determine whether a portion of the mixture is an object which exhibits a specific characteristic related to colour of the object, which characteristic is not detectable by the naked eye or a colour camera, and a separating device for separating from the mixture the objects exhibiting said characteristic as desired portions of the mixture.

Owing to these two aspects, it is possible to sort automatically objects with specific colour-related characteristics undetectable by the naked eye or a colour camera.

According to a fifth aspect of the present invention, there is provided a method comprising identifying CMYK-printed matter by irradiating the matter with radiation which is varied by the matter differently if the matter is CMYK-printed than if the matter is not CMYK-printed.

According to a sixth aspect of the present invention, there is provided apparatus for use in identifying CMYK-printed matter, comprising a radiation-emitting arrangement serving to emit radiation which is varied by the matter differently if the matter is CMYK-printed than if the matter is not CMYK-printed, and a determining arrangement serving to determine whether the varied radiation corresponds to CMYK-printed matter.

Owing to these aspects of the invention, it is possible to identify CMYK-printed matter in an automatic manner.

According to a seventh aspect of the present invention, there is provided a method of separating, from a mixture of objects, CMYK-printed objects from objects which are not CMYK-printed, comprising advancing said mixture, determining, using radiation, whether a portion of said mixture is a CMYK-printed object, and separating from the mixture the CMYK-printed objects as desired portions of the mixture.

According to an eighth aspect of the present invention, there is provided apparatus comprising a device for producing advancement of a mixture of CMYK-printed objects and objects which are not CMYK-printed, a determining arrangement which uses radiation to determine whether a portion of the mixture is a CMYK-printed object, and device for separating from the mixture the CMYK-printed objects as desired portions of the mixture.

Owing to these aspects of the invention, it is possible to sort out CMYK-printed objects from other objects in an automatic manner and so avoid manual sorting, which is not only costly but also unattractive work. In a preferred embodiment, a conveyor belt advancing a stream of waste cellulosic material is scanned over its entire width with a CMYK sensor. The type of print material and process can then be reliably identified. Printed grey and brown paperboard and cardboard are often printed in only three colours or less (usually pre-mixed colours). A CMYK sensor can detect reliably the number of printing strata and also the composition of the colours. Thus, desired paper, such as magazines, can be clearly distinguished from printed paperboard and cardboard.

The separating may be “positive”, i.e. removal of the desired portions from the stream, or “negative”, i.e. removal of unwanted portions from the stream such that the desired portions are left in the stream.

According to a ninth aspect of the present invention, there is provided a method of sorting a mixture of objects into respective fractions each having one or more characteristics common to the fraction, comprising determining the fraction to which any one object belongs by exposing the objects to radiation which is varied by the object and subjecting the varied radiation to camera image interpretation and to spectral analysis in the visible wavelength spectrum.

According to a tenth aspect of the present invention, there is provided apparatus for use in sorting a mixture of objects into respective fractions each having one or more characteristics common to the fraction, comprising a colour camera, an arrangement which applies camera image interpretation to radiation which has been varied by the objects, and a spectral analyser operable in the visible wavelength spectrum to analyse radiation which has been varied by the objects and is in the visible wavelength spectrum.

Owing to these aspects of the invention, it is possible, by combining spectral analysis in the visible wavelength spectrum and camera image interpretation, to sort more reliably the mixture of objects into separate fractions.

Thus, if it is desired to identify one or more, or even most or all, of the commonly occurring fractions in a stream of waste, for example in a stream of waste cellulosic material, and in particular to identify and separate out the fractions, such as newsprint, magazines, white ledger paper and books, of interest for production of de-inkable pulp, spectral analysis in the visible spectrum and a colour image-capturing device, such as a CCD (charge coupled device) can be employed. The colour image-capturing device can be used in determining one or more, or even most or all, of the following image characteristics of the waste objects:
Multi-colour,
Homogeneity,
Text- and print-distribution,
Surface reflectivity,
Surface area,
Colour richness,
Corner straightness,
Edge relations,
Edge properties,
   by image processing of data signals from the device. Such camera image interpretation is described in DE-A-10059034.

If such a camera were to be used alone it would seldom be able to distinguish reliably coloured cartons from illustrated magazines as, to the camera, these look very alike. Similarly, to separate grey cellusolic material from brown cellusolic material has proven difficult, based on camera image interpretation alone.

Another of the main problems up to now has been to distinguish between grey and white paper without print.

By supplementing the camera image interpretation with a spectral analysis in the visible wavelength spectrum, it is possible to overcome many of the above-mentioned problems.

If it is additionally desired to determine whether or not an object is composed of a material not detectable by spectral analysis in the visible wavelength spectrum or with camera image interpretation, such as polymer or polymer-coated material, with or without a view to separating from a mixture the object in question, NIR (Near Infrared) spectral detection can be employed. In this way, it becomes possible to identify polymer or polymer-coated objects, by spectral analysis in the invisible wavelength spectrum, which may be unwanted or may be a desired class of material.

The conveyor belt would thus also be scanned over its entire width with a NIR sensor. Such sensors are well known from polymer and plastics sorting. In this way, non-cellulosic material is identified; beverage cartons and plastics belong to this category. In particular, polymer coatings on cellulosic material can be identified. With the NIR sensor technique a number of material characteristics can be detected and distinguished.

The following are a number of examples of how camera image interpretation can supplement spectral analysis in the visible wavelength spectrum in the detection and sorting-out of CMYK-printed matter in waste sorting. The above-mentioned image characteristics are defined as follows:

“Multi-colour” means the degree to which colours such as red, green and blue are occurring and their relative shares of the surface area.

“Homogeneity” means the colour uniformity and brightness across the object.

“Text and print distribution” means determining patterns on the surface, such as the statistical distribution of black and white pixels, occurrence of column text, headings, pictures and illustrations.

“Surface reflectivity” means the degree to which incident light is reflected from the surface of an object.

“Surface Area” means the plan size of the object.

“Colour richness” means the number of colours occurring and their surface relation to each other, and also the degree of difference (contrast) to each other. This requires arranging the pixels in different colour classes.

“Corner straightness” means the degree to which the shape of the object deviates from a circumscribed rectangle.

“Edge relations” means the length relation between the longer and the shorter edges of the circumscribed rectangle.

“Edge properties” means mainly the smoothness of the edges and is a measure of how uniformly and smoothly the edges extend.

Examples of how these characteristics can be interpreted for effective sorting of waste cellulosic material are as follows:

From the “Multi-colour” characteristic a decision can be made as to whether the identified object is a coloured paper or not. The lack of “Colour richness” together with a high degree of “Homogeneity” indicates that the object is cardboard, and in particular corrugated cardboard and cartons for packaging. A supplementary characteristic can also be the surface “Reflectivity” which for almost all cardboard and cartons can be expected to be quite low. “Text and print distribution” comprises characteristics of text, illustrations etc. In particular headings, characteristics of illustrations and of areas without print, can help in deciding whether the object is newsprint or not. “Multi-colour” will also give an indication as to whether the object is an illustrated magazine or not. “Corner straightness” may also confirm that it is a magazine or newsprint. Likewise “Edge relation” can lead to a further limitation in the possible classification choice in that, for instance, magazines normally would be in a standard format, e.g. the A4 format in Europe. Cartons and cardboard can normally be identified and distinguished from paper on the basis of the “Edge properties”. Paper will normally have smooth edges, whereas torn cartons and cardboard will have jagged and frayed edges.

The colour in areas of the object without print may in many cases be characteristic of the paper type. This is often the case for paper for newsprint. Several types of carton and cardboards also have very characteristic base colours. Lightly coloured (tinted) paper usually has colours of a pastel type (pink, yellow) with a low degree of saturation.

Camera image interpretation, NIR detection and CMYK detection can be combined in a single system. In this connection it is unimportant in what sequence the sensors are scanning, if it is not done simultaneously. In one embodiment, all of the detectors (namely the NIR and CMYK sensors and the image-capturing device) scan the same transverse line across the conveyor belt.

All information from the various detectors is transmitted to a high-performance computer for processing. Algorithms are applied to identify the objects and define their respective categories and fractions.

According to a preferred embodiment, the sorting process normally is “negative” (i.e. removal of unwanted objects from the stream), and arranged in the following three steps.
1. The accurate position of the object is determined. This can be undertaken by the scanning CMYK or NIR sensors, or by means of the camera if used. Colour image interpretation, CMYK and NIR sensors yield the necessary object data.
2. The identified objects are characterised and arranged in the different waste fractions.
3. The identified undesired objects are finally ejected from the stream automatically by means of an array of controlled air jets arranged at the end of the conveyor belt.

The position detection of objects on the conveyor belt and the targeted air jet ejection is known from the sorting of plastics and polymers and described in DE-C-19751862, in which the object identification is undertaken without mechanical contact over the width of the conveyor belt, which can be 1400 mm or 2800 mm.

In order that the present invention may be clearly and completely disclosed, reference will now be made, by way of example, to the accompanying drawings, in which:

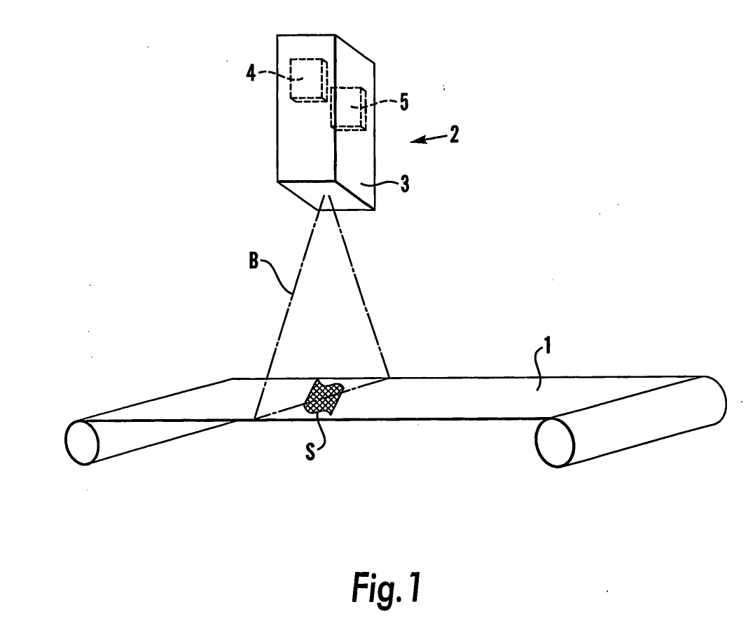

FIG. 1 shows diagrammatically a system for identifying a CMYK-printed paper object, with a view to separating it from objects which are not CMYK-printed or are not paper objects,

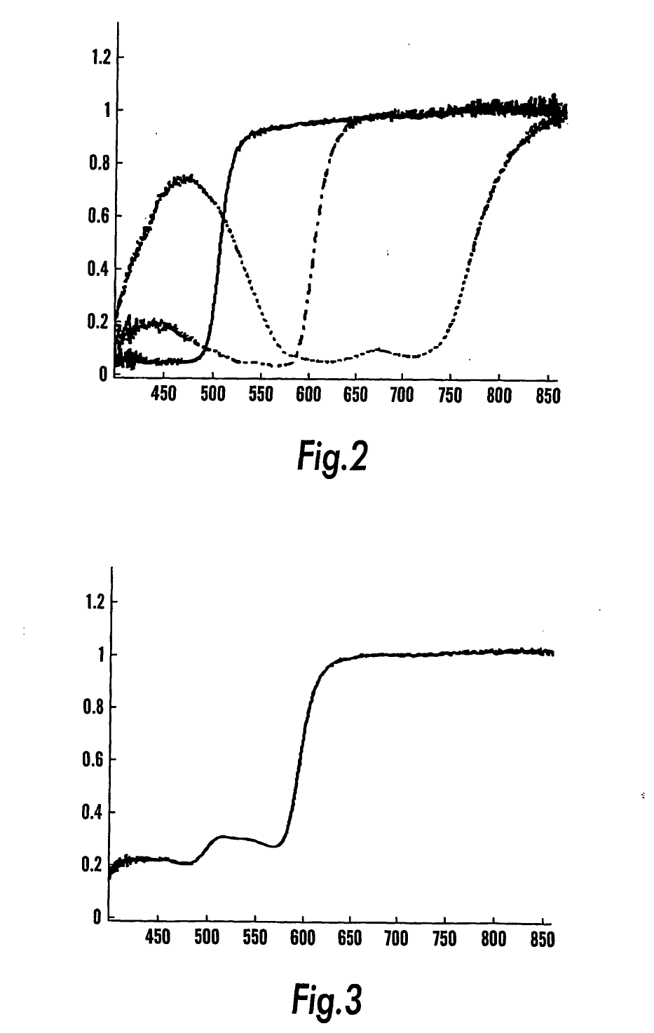

FIG. 2 is a graph of normalised light intensity plotted against wavelength and showing visible light absorption spectra for the basic colours Cyan, Yellow and Magenta of the CMYK colour range,

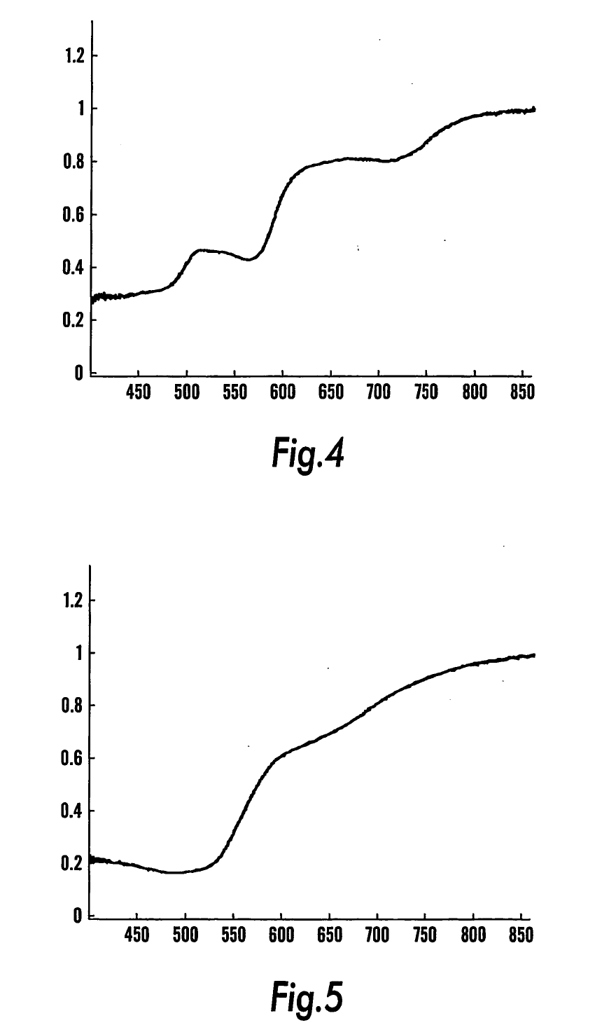

FIGS. 3 and 4 are graphs showing respective examples of spectra of combined CMYK colours,

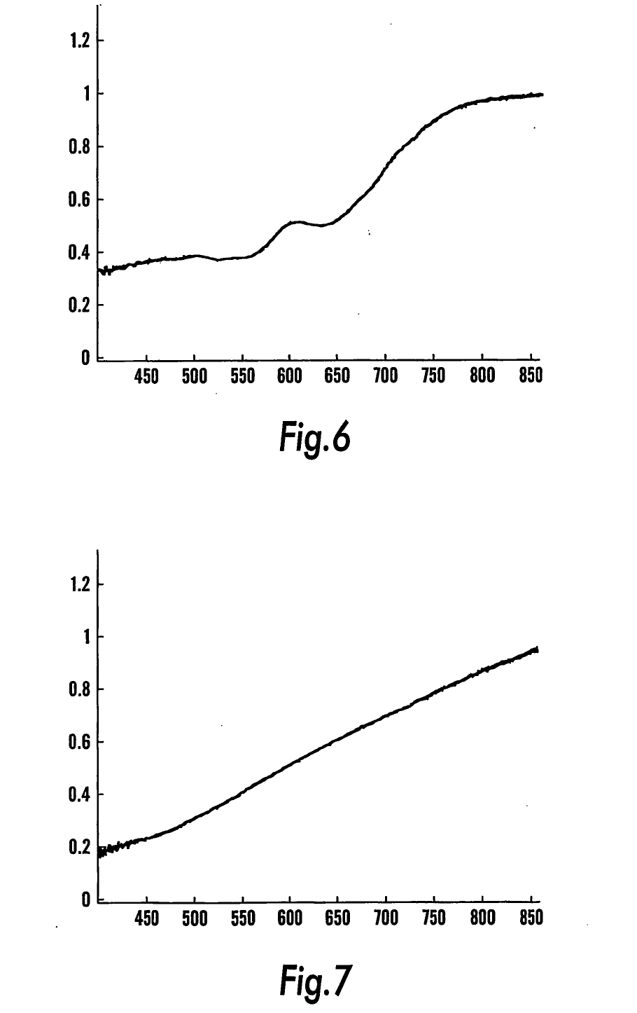

FIGS. 5 and 6 are graphs showing respective examples of spectra of non-CMYK colours,

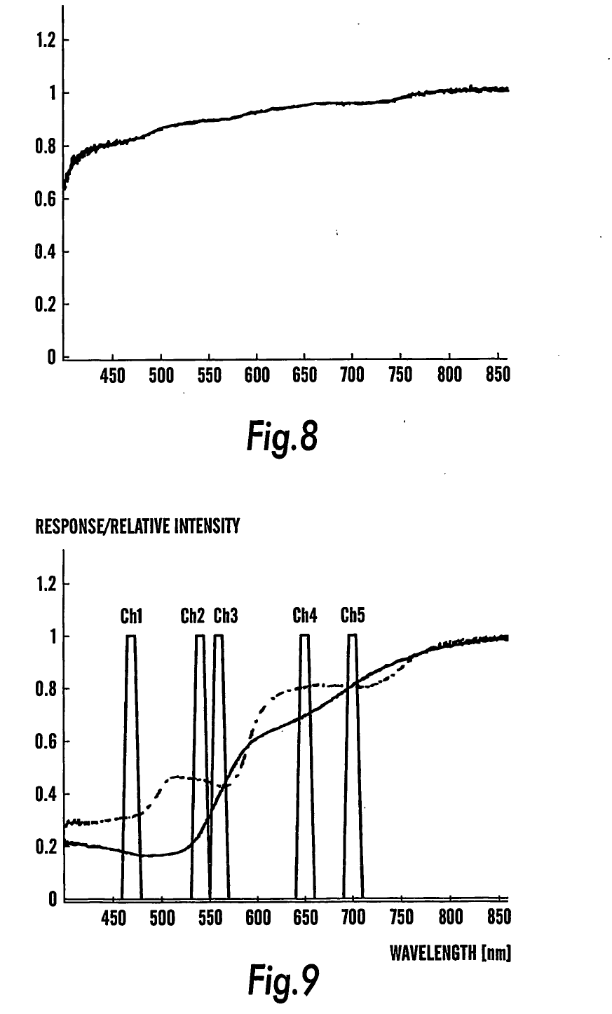

FIGS. 7 and 8 are graphs showing spectra of brown cardboard and grey cardboard, respectively,

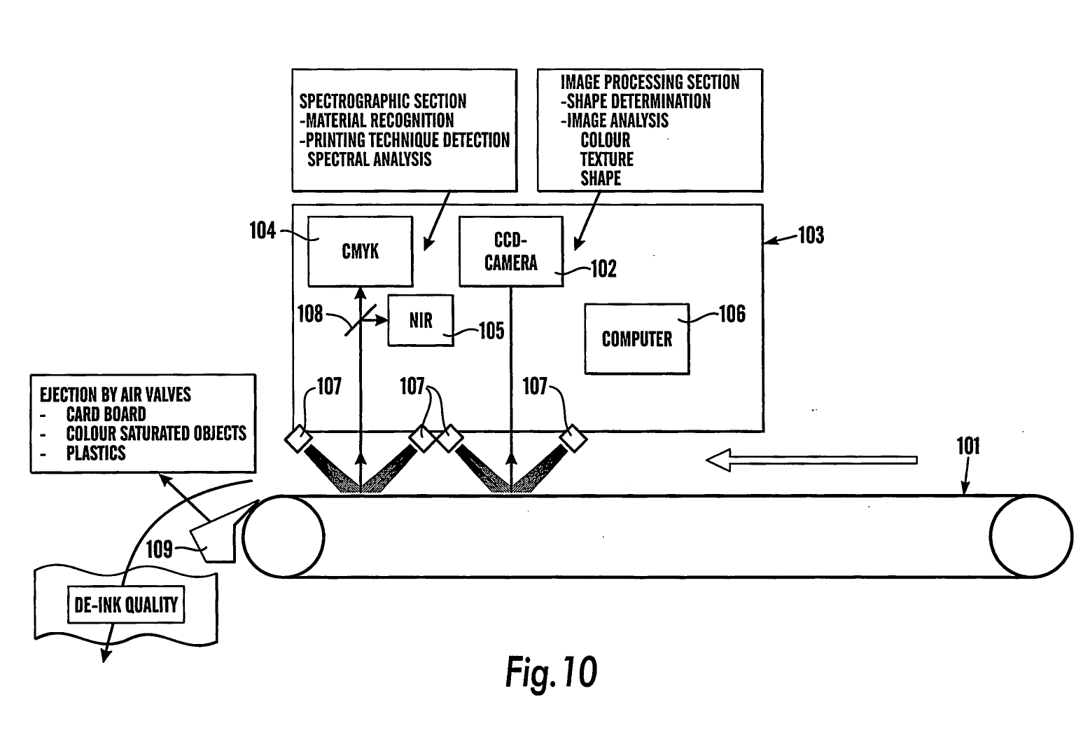

FIG. 9 is a graph showing a spectral response in an example of the present method,

FIG. 10 shows diagrammatically a modified version of the system,

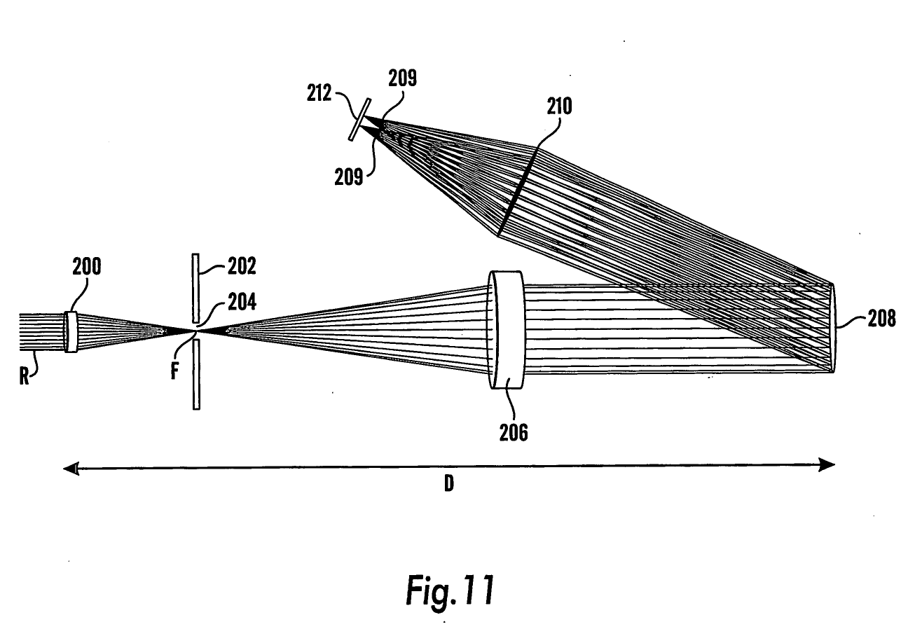

FIG. 11 shows diagrammatically an analysis unit for use in the systems of FIGS. 1 and 10 and for analysing radiation in the visible spectrum, and

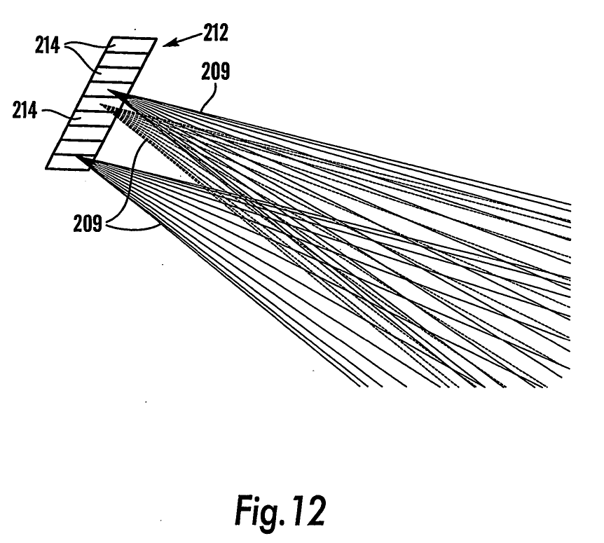

FIG. 12 shows diagrammatically part of the unit of FIG. 11.

Referring to FIGS. 1 to 9, we propose a technique to discriminate between different classes of recycled paper, e.g. the de-inkable class and the unwanted material, based on the spectral properties in the visible region of the CMYK colours. CMYK is named after the colours Cyan, Magenta, Yellow and Carbon Black that result from the colour separation process used in most image rendering printing processes today. The colours obtained by the CMYK printing process can to a large extent be identified by properties in the visible spectrum distinguishing them from colours of tinted paper materials and paper objects printed by a premixing process. This colour distinguishing technique may employ a system such as disclosed in International Patent Application Publication WO96/06689; of course, visible light would be employed rather than IR. Moreover, this colour distinguishing technique may be combined with a technique using IR (infrared)-properties to remove paperboard objects (mainly food containers) printed by the CMYK process but having some form of plastics coating. The latter technique could be that disclosed in WO96/06689. A scanning system combining both techniques is shown in FIG. 1. In the system shown, a mixture of various cellulosic sheets (S) are advanced continuously on a conveyor belt 1 past a detection station 2 having a scanner 3 which scans the stream of the advancing mixture transversely of the belt 1 and includes two analysis units 4 and 5. The radiation in the beam B reflected from the belt 1 and the sheets (S) has its visible light spectrum used by the unit 4 to identify CMYK-printed cellulosic sheets and has its IR spectrum used by the unit 5 to identify such sheets as plastics-coated cellulosic sheets. In this manner, it is possible to leave, as a main stream, only CMYK-printed paper sheets, black-and-white paper sheets and white paper sheets.

Newsprint and magazines are to a large extent CMYK printed, or printed in carbon black. Thus these may be distinguished from most other coloured paper objects by detecting the CMYK print. As mentioned CMYK may be distinguished from most other colours by the characteristics of the spectrum in the visible region. FIG. 2 shows spectra for the three basic colours Cyan (dashed line), Yellow (solid line) and Magenta (dot-dash line). FIGS. 3 and 4 show examples of spectra of images printed by the CMYK colours, whereas FIGS. 5 and 6 show spectra of non-CMYK colours, FIG. 7 shows a typical spectrum of brown cardboard, and FIG. 8 shows a typical spectrum of grey cardboard.

As a measure of the “CMYK content” of a colour we detect the differences of the spectrum intensities among two or more of a multitude of narrow-frequency-band channels. The channels may be produced by light sensors fitted with narrow band pass filters, or by placing sensors in selected positions along a spectrum generated by a dispersive element such as a grating or a prism. The number of channels is advantageously 5, 6 or more and most preferably 16. FIG. 9 shows the spectral response of a practical example with 5 channels, superposed on spectra of a typical CMYK colour spectrum (dashed line) and a non-CMYK spectrum (solid line) of a coloured paper.

One criterion for discriminating between CMYK and non-CMYK colour is differences among the levels of intensity in two or more of the channels, e.g. (Ich2−Ich1), (Ich4−Ich3) and (Ich5−Ich4). Here, Ichn means the intensity measured in channel n. Other combinations of sums and differences of channel intensities may be chosen according to the type and number of paper qualities to be sorted.

The system shown in FIG. 1, using NIR detection and CMYK detection, can be very advantageous. However, it has several limitations in covering the full range of waste cellulosic material sorting demands. The system shown in FIG. 10 is better able to cover that full range, since it employs additionally a colour camera, particularly a CCD (charge coupled device) camera.

As shown in FIG. 10, a conveyor belt 101 transports the waste cellulosic material beneath a CCD camera 102 contained in a casing 103, which also contains a CMYK sensor 104, a NIR sensor 105 and a computer 106 to which are fed the outputs from the items 102, 104 and 105. The sensors 104 and 105 receive radiation from lamps 107 as reflected from the waste stream, via a beam splitter 108. The computer 106 controls the operation of air valves for compressed air nozzles 109 so as to eject unwanted material, such as cardboard, colour-saturated objects and plastics from the stream, which continues as desired material of de-inkable quality.

The CMYK and NIR sensors 104 and 105 and the colour camera 102 scan the entire width of the conveyor belt 101. In this embodiment, the camera 102 is placed upstream of the other scanning sensors 104 and 105, and has a resolution sufficient to recognise printed text on the objects.

As the optical colour camera 102 a three-CCD, line camera (red, green and blue) is recommended. The resolution can here be 2000 pixels per line, and theoretically up to 8000 lines per second can be scanned, although the scanning speed is likely to be somewhat lower, because of the limited processing capacity of the image analysis computer 106.

This technology also allows, as an example, to distinguish between newsprint and grey carton, which normally is very difficult to do. The basis is the statistical distribution of black and non-black pixels, whereby areas with given distributions may be classified as text areas.

The system according to FIG. 10 can automatically sort waste into various fractions of high purity. As an example, an operator of the system has the opportunity of choosing only newsprint to be sorted out, or paperboard and cardboard, or any other desired fraction. It is also possible to set differing quality and purity standards.

The system of FIG. 10 is capable of identifying the following cellulosic material fractions:
brown cellulosic material [identification of specific colours, such as brown, light brown, dark brown, with the aid of the camera and/or the CMYK—and/or (if the material is coated) the NIR—sensors];
grey cellulosic material [identification of specific colours, such as grey, light grey, dark grey with the aid of the camera and/or the CMYK—and/or (if the material is coated) the NIR—sensors. With a high-resolution camera, newsprint can be distinguished from grey cellulosic material];
newsprint [the statistical distribution of black and white pixels in a camera image enables the reliable detection of newsprint. If colour print is present in addition to grey print, the CMYK sensor can unambiguously identify such colour print and thereby supplement the camera image interpretation. This information is applied to differentiate unambiguously between grey paperboard or cardboard and newsprint. If the operator so desires, a fraction consisting of newsprint only can be sorted out];
printed board [this is cardboard with print which cannot be identified by a colour camera alone. A CMYK sensor can give supplementary information, based on the fact that illustrated magazines always exhibit four printing colour strata, so that they can be distinguished from this printed board];
coloured paper [these can be identified by the camera owing to their typical colours such as pink and yellow, and their distribution over the surface. A CMYK sensor also gives an unambiguous identification of coloured paper. This identification is best undertaken with the combination of a camera and a CMYK sensor];

non-paper [by applying a NIR sensor, all objects that are not composed of cellulose and that do not belong in the paper fractions can be identified. This category comprises mostly all polymers such as PVC, PP, PE, PET, PS, plastics foils, and beverage cartons and food packaging cartons with polymer coatings].

To ensure an optimum performance of the system with high “hitting rate” and low content of impurities in the sorted fraction, the input material needs to meet certain requirements. The input stream often arrives in heaps and bundles, in which case it should be run through ballistic separators, star screens, screen drums and/or similar machines to try to ensure that material is arriving in a single layer, and that impurities and fragments smaller than 80-100 mm, metal impurities, and objects larger than 600 mm, are removed mechanically beforehand. Ideally, the plan size of the object on the conveyor belt 101 should correspond to the size range of the de-inkable fraction. Further, the stream of objects should be well distributed across the conveyor belt surface in a single layer and with limited overlap of objects. The system is operated with a belt speed of about 2.5 m/s preferably. A uniform input feed rate to the sorting station is of importance for an optimum system function with a high “hitting rate” and high purity of the sorted fraction. In addition, it is important that the belt 101 should operate without vibration disturbance.

If these requirements are met, a system throughput of some 3 to 4 tons per hour can be expected with a belt width of 1400 mm. The material distribution should be near to the optimum, so that the ejection of grey and brown paperboard or cardboard can be at least 80%. The de-inkable material loss, referred to the input stream before sorting, could be expected to be about 4 to 5%.

Referring to FIGS. 11 and 12, an analysing unit for analysing radiation in the visible spectrum such as the unit 4 in FIG. 1 or the unit 104 in FIG. 10 receives radiation R in the form of light in the visible spectrum reflected from the belt and the material on the belt, which passes through a convex objective lens 200 which causes the beam of radiation R to converge towards a barrier 202 having a slit 204. The barrier 202 is positioned to be at the same distance from the lens 200 as the focal point F of the lens 200 such that the beam of radiation R passes through the slit 204 at the focal point F. Once the radiation R has passed through the slit 204, the beam of radiation diverges to a collimating lens 206 which causes the beam to become parallel. The parallel beam then impinges on a dispersive element in the form of a grating 208. The grating 208 causes the beam of radiation R to be reflected as a plurality of narrow wavelength band beams 209 parallel to each other and distributed across the visible spectrum, each narrow wavelength band beam 209 being reflected along a slightly different path. The distance between the objective lens 200 and the grating 208 is approximately 200 mm.

The radiation reflected from the grating 208 passes through a convex focusing lens 210 which focuses the beams of light onto a detector 212. The detector 212 comprises a plurality of sensors 214, as shown in FIG. 12. Individual narrow wavelength band beams 209 are focused by the lens 210 onto individual sensors 214 which each produce a signal corresponding to the intensity of radiation which the sensor receives. The signals from the sensors 214 are fed to a computer such as the computer 106 described in relation to FIG. 10.

The slit 204 has an optimum width of approximately 0.4 mm which results in a detection resolution of 20 nm, i.e. it is possible to distinguish differences in intensity of radiation which are only 20 nm apart. A larger slit width will have the result of reducing the resolution and thereby may decrease the reliable detection of the material. Conversely, a narrower slit will increase the detection resolution such that differences in intensity of radiation can be detected between wavelengths less than 20 nm apart. However, in this instance there is a significant reduction in the signal intensity received by the sensors 214.

1-80. (canceled)

81. A method of separating, from a mixture of objects, objects that exhibit a specific characteristic related color of the objects, which characteristic is not detectable by the naked eye or a color camera, comprising advancing said mixture, determining, using radiation, whether a portion of said mixture exhibits said characteristic and separating from the mixture the objects exhibiting said characteristic as desired portions of the mixture.

82. A method according to claim 81, wherein said determining comprises analyzing, in a plurality of narrow wavelength bands in the visible spectrum, such radiation varied by said portion.

83. A method according to claim 82, in which said plurality is at least five.

84. A method according to claim 82, in which each wavelength band is no more than 50 nanometers in width.

85. A method according to claim 82, and of determining color of said matter and thereby whether said matter is or is not CMYK-printed matter, wherein said bands include a band in the region of 550 nanometers and a band in the region of 650 nanometers.

86. A method according to claim 82, and additionally applying camera image interpretation to such varied radiation.

87. A method according to claim 82, and additionally analyzing such varied radiation in the invisible wavelength spectrum.

88. Apparatus comprising a device for producing advancement of a mixture of objects, a determining arrangement which uses radiation to determine whether a portion of the mixture is an object which exhibits a specific characteristic related to color of the object, which characteristic is not detectable by the naked eye or a color camera, and a separating device for separating from the mixture the objects exhibiting said characteristic as desired portions of the mixture.

89. Apparatus according to claim 88, wherein said determining arrangement comprises a detecting arrangement serving to detect such radiation varied by said portion, and an analyzing arrangement serving to analyze the varied radiation in a plurality of narrow wavelength bands in the visible spectrum.

90. Apparatus according to claim 89, in which said plurality is at least five.

91. Apparatus according to claim 89, in which each 15 wavelength band is no more than 50 nanometers in width.

92. Apparatus according to claim 89, and for use in determining color of said matter and thereby whether said matter is or is not CMYK-printed matter, wherein said bands include a band in the region of 550 nanometers and a band in the region of 650 nanometers.

93. Apparatus according to claim 89, therein said detecting arrangement comprises light sensors provided with narrow band filters.

94. Apparatus according to claim 89, wherein said detecting arrangement comprises a spectrum-generating, light-dispersive element, and light sensors distributed so as to be distributed along said spectrum when generated.

95. Apparatus according to claim 94, wherein said element is a grating or a prism.

96. Apparatus according to claim 89, wherein said analyzing arrangement serves to analyze also such varied radiation in the invisible wavelength spectrum.

97. Apparatus according to claim 88, and further comprising a color camera and a device arranged to receive the output from said camera and to perform camera image interpretation.

98. A method comprising identifying CMYK-printed matter by irradiating the matter with radiation which is varied by the matter differently if the matter is CMYK-printed than if the matter is not CMYK-printed.

99. A method according to claim 98, wherein said determining includes analyzing, in a plurality of narrow wavelength bands in the visible spectrum, such varied radiation.

100. A method according to claim 99, in which said plurality is at least five.

101. A method according to claim 99, in which each wavelength band is no more than 50 nanometers in width.

102. A method according to claim 99, wherein said bands 10 include a band in the region of 550 nanometers and a band in the region of 650 nanometers.

103. Apparatus for use in identifying CMYK-printed matter, comprising a radiation-emitting arrangement serving to emit radiation which is varied by the matter differently if the matter is CMYK-printed than if the matter is not CMYK-printed, and a determining arrangement serving to determine whether the varied radiation corresponds to CMYK-printed matter.

104. Apparatus according to claim 103, wherein said determining arrangement comprises a detecting arrangement serving to detect the varied radiation diffusely reflected from said matter, and an analyzing arrangement serving to analyze the diffusely reflected radiation in a plurality of narrow wavelength bands in the visible spectrum.

105. Apparatus according to claim 104, in which said plurality is at least five.

106. Apparatus according to claim 104, in which each wavelength band is no more than 50 nanometers in width.

107. Apparatus according to claim 104, and for use in determining color of said matter and thereby whether said matter is or is not CMYK-printed matter, wherein said bands include a band in the region of 550 nanometers and a band in the region of 650 nanometers.

108. Apparatus according to claim 104, wherein said detecting arrangement comprises light sensors provided with narrow band filters.

109. Apparatus according to claim 104, wherein said detecting arrangement comprises a spectrum-generating, light-dispersive element, and light sensors distributed so as to be distributed along said spectrum when generated.

110. Apparatus according to claim 109, wherein said element is a grating or a prism.

111. A method of separating, from a mixture of objects, CMYK-printed objects from objects which are not CMYK-printed, comprising advancing said mixture, determining, using radiation, whether a portion of said mixture is a CMYK-printed object, and separating from the mixture the CMYK-printed objects as desired portions of the mixture.

112. A method according to claim 111, wherein said determining comprises analyzing, in a plurality of narrow wavelength bands in the visible spectrum, such radiation diffusely reflected from said portion.

113. A method according to claim 112, in which said plurality is at least five.

114. A method according to claim 112, in which each wavelength band is no more than 50 nanometers in width.

115. A method according to claim 112, and of determining color of said matter and thereby whether said matter is or is not CMYK-printed matter, wherein said bands include a band in the region of 550 nanometers and a band in the region of 650 nanometers.

116. Apparatus comprising a device for producing advancement of a mixture of CMYK-printed objects and objects which are not CMYK-printed, a determining arrangement which uses radiation to determine whether a portion of the mixture is a CMYK-printed object, and device for separating from the mixture the CMYK-printed objects as desired portions of the mixture.

117. Apparatus according to claim 116, wherein said determining arrangement comprises a detecting arrangement serving to detect such radiation diffusely reflected from said portion, and an analyzing arrangement serving to analyze the diffusely reflected radiation in a plurality of narrow wavelength bands in the visible spectrum.

118. Apparatus according to claim 117, in which said plurality is at least five.

119. Apparatus according to claim 117, in which each wavelength band is no more than 50 nanometers in width.

120. Apparatus according to claim 117, and for use in determining color and thereby whether said matter is or is not CMYK-printed matter, wherein said bands include a band in the region of 550 nanometers and a band in the region of 650 nanometers.

121. Apparatus according to claim 117, wherein said detecting arrangement comprises light sensors provided with narrow band filters.

122. Apparatus according to claim 117, wherein said detecting arrangement comprises a spectrum-generating, light-dispersive element, and light sensors distributed so as to be distributed along said spectrum when generated.

123. Apparatus according to claim 122, wherein said element is a grating or a prism.

124. A method of sorting a mixture of objects into respective fractions each having one or more characteristics common to the fraction, comprising determining the fraction to which any one object belongs by exposing the objects to radiation which is varied by the object and subjecting the varied radiation to camera image interpretation and to spectral analysis in the visible wavelength spectrum.

125. A method according to claim 124, and further comprising subjecting such varied radiation to spectral analysis in the invisible wavelength spectrum.

126. A method according to claim 124, wherein said spectral analysis in the visible wavelength spectrum is in a plurality of narrow wavelength bands in the visible spectrum.

127. Apparatus for use in sorting a mixture of objects into respective fractions each having one or more characteristics common to the fraction, comprising a color camera, an arrangement which applies camera image interpretation to radiation which has been varied by the objects, and a spectral analyzer operable in the visible wavelength spectrum to analyze radiation which has been varied by the objects and is in the visible wavelength spectrum.

128. Apparatus according to claim 127, and further comprising a spectral analyzer operable in the invisible wavelength spectrum to analyze radiation which has been varied by the objects and is in the invisible wavelength spectrum.

129. Apparatus according to claim 127, wherein said spectral analyzer operable in the visible wavelength spectrum performs analysis in a plurality of narrow wavelength bands in the visible spectrum.

130. A method of sorting matter, including advancing the matter, and determining color and/or composition of the advancing matter by irradiating the matter with radiation which is varied by the matter, and analyzing the varied radiation in at least five narrow wavelength bands in the visible spectrum.

131. A method according to claim 130, in which each wavelength band is no more than 50 nanometers in width.

132. A method according to claim 130, and of determining color of said matter and thereby whether said matter is or is not CMYK-printed matter, wherein said bands include a band in the region of 550 nanometers and a band in the region of 650 nanometers.

133. A method according to claim 130, and of determining color and/or composition characteristic(s) that are not detectable by the naked eye or by a color camera.

134. A method according to claim 130, and additionally applying camera image interpretation to such varied radiation.

135. A method according to claim 134, wherein uncoated brown cellulosic material is identified and/or uncoated grey cellulosic material is identified.

136. A method according to claim 134, wherein colored or tinted paper or board is identified.

137. A method according to claim 130, and additionally analyzing such varied radiation in the invisible wavelength spectrum.

138. A method according to claim 137, and additionally applying camera image interpretation to such varied radiation, wherein coated brown cellulosic material is identified and/or coated grey cellulosic material is identified.

139. A method according to claim 137, and additionally applying camera image interpretation to such varied radiation, wherein printed board is identified.

140. Apparatus for use in sorting matter, including an advancing device for advancing the matter, a radiation-emitting device serving to emit radiation which is varied by the advancing matter, a detecting arrangement serving to detect the varied radiation, and an analyzing arrangement serving to analyze the varied radiation in at least five narrow wavelength bands in the visible spectrum in order to determine color and/or composition of the matter.

141. Apparatus according to claim 140, in which each wavelength band is no more than 50 nanometers in width.

142. Apparatus according to claim 140, and for use in determining color of said matter and thereby whether said matter is or is not CMYK-printed matter, wherein said bands include a band in the region of 550 nanometers and a band in the region of 650 nanometers.

143. Apparatus according to claim 140, wherein said detecting arrangement comprises light sensors provided with narrow band filters.

144. Apparatus according to claim 140, wherein said detecting arrangement comprises a spectrum-generating, light-dispersive element, and light sensors distributed so as to be distributed along said spectrum when generated.

145. Apparatus according to claim 144, wherein said element is a grating or a prism.

146. Apparatus according to claim 140, and further comprising a color camera and a device arranged to receive the output from said camera and to perform camera image interpretation.

147. Apparatus according to claim 140, wherein said analyzing arrangement serves to analyze also such varied radiation in the invisible wavelength spectrum.

148. A method of separating a de-inkable class of recyclable paper from unwanted material, comprising advancing a mixture comprised of said de-inkable class of recyclable paper and said unwanted material, determining, using radiation, whether a portion of said mixture is of said de-inkable class, and separating from the mixture the de-inkable class of recyclable paper as desired portions of the mixture.

149. A method according to claim 148, wherein said determining comprises analyzing, in a plurality of narrow wavelength bands in the visible spectrum, such radiation diffusely reflected from said portion.

150. A method according to claim 149, in which said plurality is at least five.

151. A method according to claim 149, in which each wavelength band is no more than 50 nanometers in width.

152. A method according to claim 149, and of determining color of said portion and thereby whether said portion is or is not of said de-inkable class, wherein said bands include a band in the region of 550 nanometers and a band in the region of 650 nanometers.

153. Apparatus comprising a device for producing advancement of a mixture of a de-inkable class of recyclable paper and unwanted material, a determining arrangement which uses radiation to determine whether a portion of the mixture is of said de-inkable class, and a device for separating from the mixture the said de-inkable class of recyclable paper as desired portions of the mixture.

154. Apparatus according to claim 153, wherein said determining arrangement comprises a detecting arrangement serving to detect such radiation diffusely reflected from said portion, and an analyzing arrangement serving to analyze the diffusely reflected radiation in a plurality of narrow wavelength bands in the visible spectrum.

155. Apparatus according to claim 154, in which said plurality is at least five.

156. Apparatus according to claim 154, in which each wavelength band is no more than 50 nanometers in width.

157. Apparatus according to claim 154, and for use in determining color of said portion and thereby whether said portion is or is not of said de-inkable class, wherein said bands include a band in the region of 550 nanometers and a band in the region of 650 nanometers.

158. Apparatus according to claim 154, wherein said detecting arrangement comprises light sensors provided with narrow band filters.

159. Apparatus according to claim 154, wherein said detecting arrangement comprises a spectrum-generating, light-dispersive element, and light sensors distributed so as to be distributed along said spectrum when generated.

160. Apparatus according to claim 159, wherein said element is a grating or a prism.
